(19) United States
(12) Patent Application Publication
(10) Pub. No.: US 2016/0042386 A1
(43) Pub. Date: Feb. 11, 2016

(54) METHOD AND SYSTEM FOR PROVIDING MARKETING MESSAGES

(71) Applicant: MASTERCARD ASIA PACIFIC PTE LTD., Singapore (SG)

(72) Inventors: Vikhyat SHUKLA, Haryana (IN); Sheetanshu D. GUPTA, Rajasthan (IN); Ashutosh SHARAN, Haryana (IN)

(73) Assignee: MASTERCARD ASIA PACIFIC PTE LTD., Singapore (SG)

(21) Appl. No.: 14/816,504

(22) Filed: Aug. 3, 2015

(30) Foreign Application Priority Data
Aug. 7, 2014 (SG) 10201404724Q

(51) Int. Cl. G06Q 30/02

(52) U.S. Cl. CPC G06Q 30/0243

(57) ABSTRACT

The method comprises: obtaining observation data from a first client, wherein the observation data is associated with a second client; obtaining a plurality of marketing messages; ranking the plurality of marketing messages based on the observation data associated with the second client; and sequentially providing, upon identification of the second client, the ranked marketing messages to the second client in rank order. The system has similar features.

### TECHNICAL FIELD

The present disclosure relates to method and system for providing marketing messages.

### BACKGROUND

Currently, when merchants wish to increase awareness of their products and to increase sales, they can distribute marketing messages to customers. Marketing messages such as advertisements and offers may be distributed to customers electronically (e.g. via email, Short Messaging Service (SMS) text messages, etc.). However, merchants would need to obtain and keep an updated record of each customer's electronic address (e.g. email address, mobile phone number). If a customer changes his mobile phone number and does not update the merchant, the marketing messages may no longer reach the customer.

Even if marketing messages are successfully distributed to customers, awareness may still not be created, since the customer may trash such marketing messages. This happens especially because such marketing messages are indiscriminately sent.

A need therefore exists to provide a method and system for providing marketing messages that seeks to address at least the above-mentioned problems.

### SUMMARY

According to the first aspect, there is provided a method of providing marketing messages, comprising: obtaining observation data from a first client, wherein the observation data is associated with a second client; obtaining a plurality of marketing messages; ranking the plurality of marketing messages based on the observation data associated with the second client; and sequentially providing, upon identification of the second client, the ranked marketing messages to the to the second client in rank order.

In an embodiment, ranking the plurality of marketing messages may comprise processing the observation data and the marketing messages using a statistical model to generate a score indicative of the probability of the marketing message being of interest to the second client.

In an embodiment, ranking the plurality of marketing messages may be based on the generated score associated with each marketing message.

In an embodiment, the statistical model may be based on logistic regression.

In an embodiment, the plurality of marketing messages may comprise offers and/or advertisements.

In an embodiment, the step of obtaining observation data from the first client may comprise: obtaining a second client identifier during a transaction at a point-of-sale terminal; consulting a database having stored thereon the observation data associated with the second client; and retrieving the observation data associated with the second client using the obtained second client identifier. Alternatively, the step of obtaining observation data from the first client may comprise obtaining a second client identifier during a transaction at a point-of-sale terminal; and after the step of ranking the plurality of marketing messages, the method may further comprise storing in a database, the ranked marketing messages that are linked to the second client identifier.

In an embodiment, the method may further comprise the step of authenticating the second client during the transaction; and wherein the step of providing the ranked marketing messages may further comprise transmitting the ranked marketing messages to the point-of-sale terminal upon successful authentication of the second client.

In an embodiment, the observation data may comprise one of more of: the second client's historical transaction data, demographic data, geographic data, social media data and Internet browsing history.

In an embodiment, the marketing messages may comprise offers and the observation data may comprise the second client's response to previously provided offers.

In an embodiment, the marketing messages may comprise offers so that ranking of the marketing messages provides ranked offers, wherein a subsequent one of the ranked offers may be provided after a previously provided ranked offer is accepted by the second client.

In an embodiment, the step of sequentially providing the ranked marketing messages to the second client may comprise providing one marketing message at a time. Alternatively, sequentially providing the ranked marketing messages to the second client may comprise providing more than one marketing message at a time.

In an embodiment, the method further comprises providing the ranked marketing messages to the second client in a loop, wherein a highest ranked marketing message may be provided again after all the ranked marketing messages have been provided.

According to the second aspect , there is provided a system for providing marketing messages, comprising: at least one processor; and at least one memory including computer program code; the at least one memory and the computer program code configured to, with at least one processor, cause the system at least to: obtain observation data from a first client, wherein the observation data is associated with a second client; obtain a plurality of marketing messages; rank the plurality of marketing messages based on the observation data associated with the second client; and sequentially provide, upon identification of the second client, the ranked marketing messages to the to the second client in rank order.

According to the third aspect, there is provided a point-of-sale terminal adapted to receive and display marketing messages provided by the method according to the first aspect.

According to the fourth aspect, there is provided a computer-readable storage medium having stored thereon computer program code which when executed by a computer causes the computer to execute the method according to the first aspect.

According to the fifth aspect, there is provided a computer program comprising software code adapted to perform the method according to the first aspect.

### BRIEF DESCRIPTION OF THE DRAWINGS

Example embodiments will be better understood and readily apparent to one of ordinary skill in the art from the following written description, by way of example only, and in conjunction with the drawings, in which:

FIG. 1 is a block diagram of a system for providing marketing messages produced by the method as illustrated in FIG. 3;

FIG. 2 is a schematic diagram of a computing device which is configured to implement the method as illustrated in FIG. 3;

FIG. 3 is a flow chart illustrating a method of providing marketing messages in accordance with an embodiment of the present invention;

FIG. 4 is a tabular representation of the manner in which observation data is kept in a database; and

FIG. 5 is a tabular representation of the manner in which marketing messages are kept in a database.

### DETAILED DESCRIPTION

Embodiments will be described, by way of example only, with reference to the drawings. Like reference numerals and characters in the drawings refer to like elements or equivalents.

Some portions of the description which follow are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “obtaining”, “scanning”, “calculating”, “determining”, “replacing”, “generating”, “initializing”, “outputting”, “establishing”, “receiving”, “sending”, “identifying”, “transmitting”, “comparing”, “extracting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods disclosed herein. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program and the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer-readable medium. The computer-readable medium may include storage devices such as magnetic or optical disks, memory chips, or other storage devices suitable for interfacing with a general purpose computer. The computer-readable medium may also include a hard-wired medium such as exemplified in the Internet system, or wireless medium such as exemplified in the GSM, GPRS, 3G or 4G mobile telephone systems. The computer program when loaded and executed on such a general-purpose computer effectively results in an apparatus that implements the steps of a method in accordance with an embodiment of the invention.

The disclosed system may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

Various embodiments relate to a method and a corresponding system, computer-readable storage medium and computer program for providing marketing messages to one or more clients. The marketing messages may be offers and/or advertisements relating to products offered by the merchant. Offers may include a discount on certain products offered by the merchant, extra loyalty reward points when certain products are purchased, etc. to encourage customers to purchase certain products. Advertisements may include announcements on new product launches, opening of new store outlets, etc. to create awareness of certain aspects of the merchant's business.

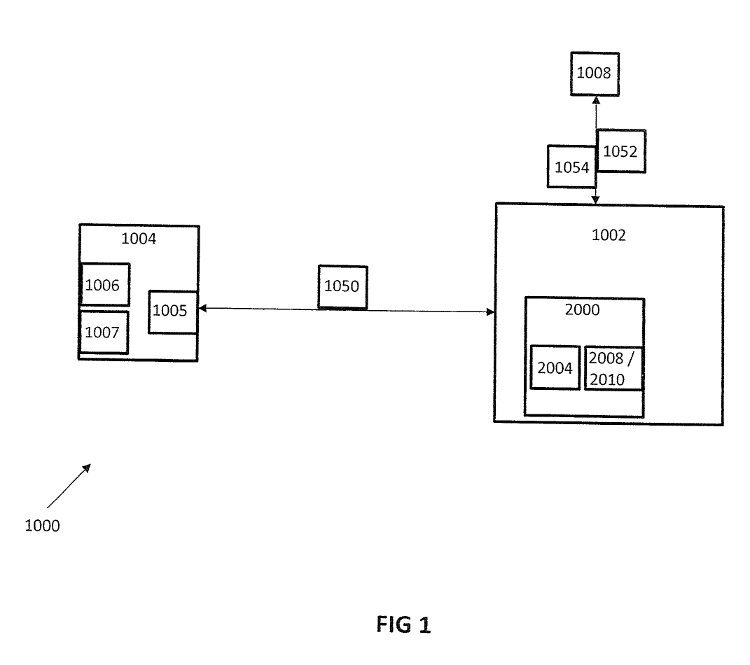

FIG. 1 is a block diagram of a system 1000 for providing marketing messages. The system 1000 may comprise one or more servers 1002, and one or more point-of-sale terminals 1004. Optionally, the system 1000 may further comprise a separate storage drive 1008 having stored thereon observation data and/or marketing messages. However, for conciseness, the following description of the system 1000 relates to a single server 1002 and point-of-sale terminal 1004. Therefore, only one server 1002 and one point-of-sale terminal 1004 is shown in FIG. 1.

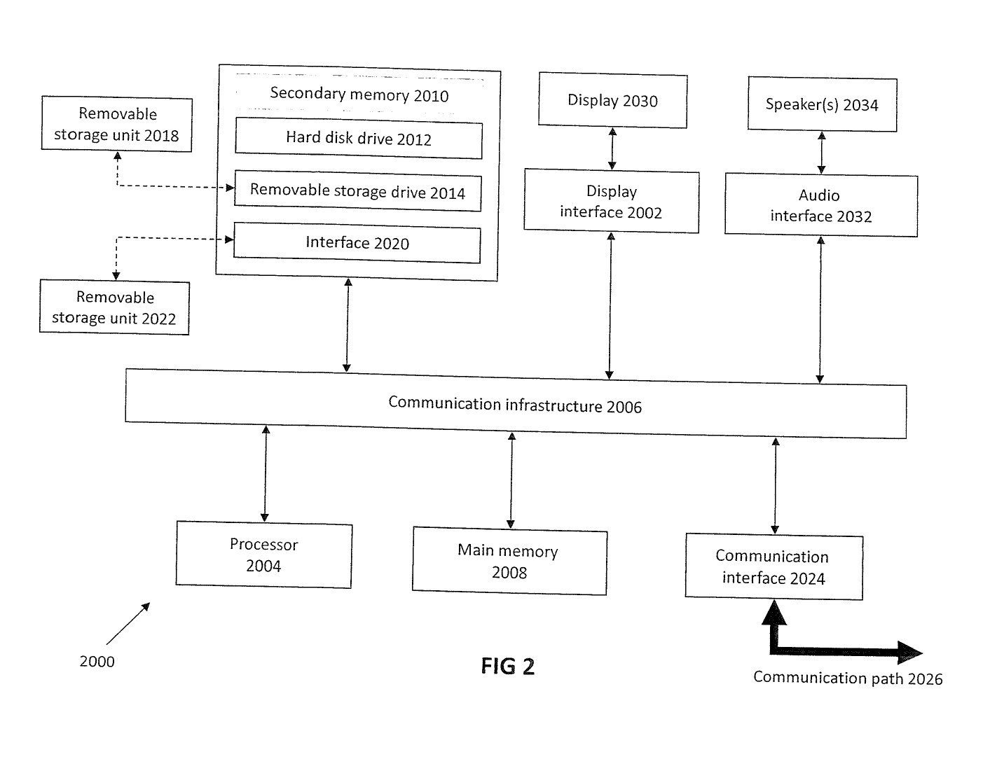

The point-of-sale terminal 1004 is in communication with the server 1002. The server 1002 may comprise one or more computing devices, where each may be implemented using computing device 2000 that will be described in more detail below with reference to FIG. 2. Only one computing device 2000 is shown, and the computing device 2000 comprises a processor 2004 and memory 2008/2010 including computer program code. The memory 2008/2010 and the computer program code is configured to, with the processor 2004, cause the server 1002 at least to:

Obtain observation data from a first client, wherein the observation data is associated with a second client. The “first client” may be a financial institution, such as a bank, or a payment facilitator (e.g. MasterCard®) who facilitates payments between entities (e.g. an acquiring bank and an issuing bank). The “second client” may be a customer/consumer of products offered by a merchant. The observation data may include behavioral data associated with the second client, such as the second client's historical transaction data, response to previously provided marketing messages (e.g. offers) and Internet browsing history. The observation data may also include demographic data, geographic data and social media data associated with the second client. Social media data includes, but is not limited to, data obtained from the second client's participation in social networks such as Twitter™, Facebook™, LinkedIn™, etc.
For conciseness, the following description may only refer to a single entity, e.g. one second client. However, it is to be understood that the methods and systems described herein can be adapted to accommodate multiple entities (i.e. multiple first clients, second clients and/or merchants). For example, the methods and systems can be adapted to accommodate a large number of participating customers/consumers, each participating customer/consumer having his/her own set of observation data.
The observation data may be stored in a database and administered by the first client. The database may reside in the secondary memory 2010 of the computing device 2000. Alternatively, the database may reside in a storage drive 1008 located external to the server 1002. The storage drive 1008 is in communication with the server 1002. The observation data may be obtained from the first client by receiving the observation data (depicted by the data packet 1052) from the storage drive 1008.
Obtain a plurality of marketing messages. The marketing messages may be offers and/or advertisements relating to products offered by the merchant.
The marketing messages may be stored in a database, preferably, but not necessarily, separate from the database that stores the observation data. This database may reside in the secondary memory 2010 of the computing device 2000. Alternatively, this database may reside in the storage drive 1008 located external to the server 1002. The storage drive 1008 is in communication with the server 1002. The plurality of marketing messages may be obtained by receiving the plurality of marketing messages (depicted by the data packet 1054) from the storage drive 1008.
Rank the plurality of marketing messages based on the observation data associated with the second client. The marketing messages may be ranked such that the highest ranked marketing message is determined to be most likely to be of interest to the second client, and the lowest ranked marketing message is determined to be least likely to be of interest to the second client. Ranking allows the marketing messages to be targeted in the sense that the second client receives marketing messages which are expected to be most appealing to him/her, where the most appealing one may be presented first based on the observation data associated with the second client. In this manner, merchants are able to reach their prospective customers more effectively and marketing messages which may not appeal to customers are not sent to them. The ranking of the plurality of marketing messages may be based on an ad-hoc ranking scheme or a pre-ranking scheme, as will be described in more detail below.
Sequentially provide, upon identification of the second client, the ranked marketing messages to the second client in rank order (e.g. starting with the highest ranked marketing message). The second client first receives a marketing message which is expected to be most appealing to him/her. The second marketing message that is received is expected to be less appealing to him/her than the first message. The last marketing message that is received is expected to be the least appealing to him/her compared to all the messages received previously. In the case of the marketing message being an offer, the offer may be provided only if the second client is eligible for the offer. For example, if the offer is upgrade a credit card from a lower credit limit to a higher credit limit, the second client should be eligible for the upgrade; otherwise, the offer is not provided. It is also possible to sequentially provide, upon identification of the second client, the ranked marketing messages to the second client starting with the lowest ranked marketing message.

The point-of-sale terminal 1004 is adapted to receive (depicted using the data packet 1050 in FIG. 1) and display the marketing messages provided by the server 1002. The point-of-sale terminal 1004 may comprise a receiver module 1005 for receiving the marketing messages from the server 1002, a display screen 1006 for displaying the marketing messages, and/or an input module 1007 (e.g. a keypad) for receiving inputs from the second client in response to the marketing messages. For example, if an offer appeals to the second client, he/she can accept the offer and a corresponding voucher can be sent to the second client's mobile phone. The second client can also use the input module 1007 to browse the ranked marketing messages. For example, after receiving the first marketing message, the second client may wish to view another marketing message. A suitable input can be used to trigger the display of the second marketing message (and subsequent marketing messages) on the display screen 1006.

Use of the term ‘server’ herein may be understood to mean a single computing device or a plurality of interconnected computing devices which operate together to perform a particular function. That is, the server may be contained within a single hardware unit or be distributed among several or many different hardware units.

An exemplary computing device 2000, to realize one or more of such servers 1002, is shown in FIG. 2. The following description of the computing device 2000 is provided by way of example only and is not intended to be limiting. Therefore, one or more elements/components of the computing device 2000 may be omitted. Also, one or more elements/components of the computing device 2000 may be combined together. Additionally, one or more elements/components of the computing device 2000 may be split into one or more component parts.

With reference to FIG. 2, the exemplary computing device 2000 includes a processor 2004 for executing software routines. Although a single processor is shown for the sake of clarity, the computing device 2000 may also include a multi-processor system. The processor 2004 is connected to a communication infrastructure 2006 for communication with other components of the computing device 2000. The communication infrastructure 2006 may include, for example, a communications bus, cross-bar, or network.

The computing device 2000 further includes a main memory 2008, such as a random access memory (RAM), and a secondary memory 2010. The secondary memory 2010 may include, for example, a hard disk drive 2012 and/or a removable storage drive 2014, which may include a floppy disk drive, a magnetic tape drive, an optical disk drive, or the like. The removable storage drive 2014 reads from and/or writes to a removable storage unit 2018 in a well-known manner. The removable storage unit 2018 may include a floppy disk, magnetic tape, optical disk, or the like, which is read by and written to by removable storage drive 2014. As will be appreciated by persons skilled in the relevant art(s), the removable storage unit 2018 includes a computer readable storage medium having stored therein computer executable program code instructions and/or data.

In an alternative implementation, the secondary memory 2010 may additionally or alternatively include other similar means for allowing computer programs or other instructions to be loaded into the computing device 2000. Such means can include, for example, a removable storage unit 2022 and an interface 2020. Examples of a removable storage unit 2022 and interface 2020 include a program cartridge and cartridge interface (such as that found in video game console devices), a removable memory chip (such as an EPROM or PROM) and associated socket, and other removable storage units 2022 and interfaces 2020 which allow software and data to be transferred from the removable storage unit 2022 to the computing device 2000.

The computing device 2000 also includes at least one communication interface 2024. The communication interface 2024 allows software and data to be transferred between computing device 2000 and external devices via a communication path 2026. In various embodiments of the inventions, the communication interface 2024 permits data to be transferred between the computing device 2000 and a data communication network, such as a public data or private data communication network. The communication interface 2024 may be used to exchange data between different computing devices 2000 which such computing devices 2000 form part an interconnected computer network. Examples of a communication interface 2024 can include a modem, a network interface (such as an Ethernet card), a communication port, an antenna with associated circuitry and the like. The communication interface 2024 may be wired or may be wireless. Software and data transferred via the communication interface 2024 are in the form of signals which can be electronic, electromagnetic, optical or other signals capable of being received by communication interface 2024. These signals are provided to the communication interface via the communication path 2026.

As shown in FIG. 2, the computing device 2000 further includes a display interface 2002 which performs operations for rendering images to an associated display 2030 and an audio interface 2032 for performing operations for playing audio content via associated speaker(s) 2034.

As used herein, the term “computer program product” may refer, in part, to removable storage unit 2018, removable storage unit 2022, a hard disk installed in hard disk drive 2012, or a carrier wave carrying software over communication path 2026 (wireless link or cable) to communication interface 2024. A computer readable medium can include magnetic media, optical media, or other recordable media, or media that transmits a carrier wave or other signal. These computer program products are devices for providing software to the computing device 2000.

The computer programs (also called computer program code) are stored in main memory 2008 and/or secondary memory 2010. Computer programs can also be received via the communication interface 2024. Such computer programs, when executed, enable the computing device 2000 to perform one or more features of embodiments discussed herein. In various embodiments, the computer programs, when executed, enable the processor 2004 to perform features of the described embodiments. Accordingly, such computer programs may represent controllers of the computing device 2000.

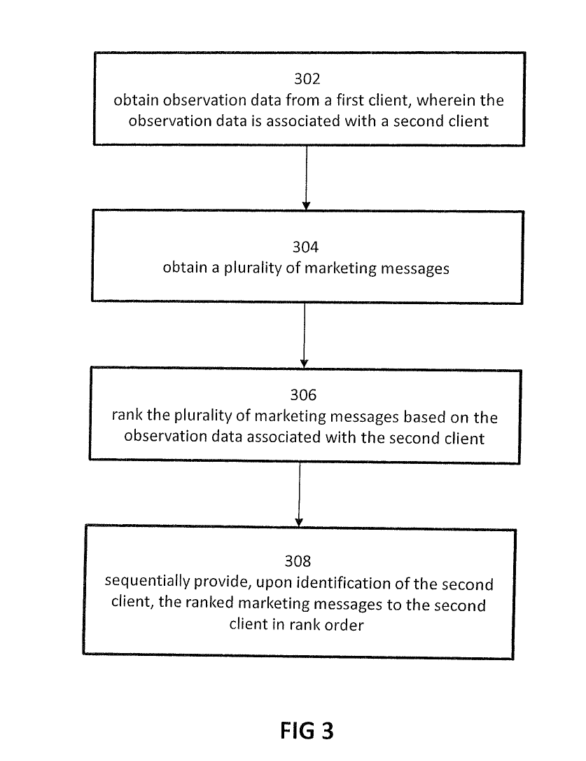

Software may be stored in a computer program product and loaded into the computing device 2000 using the removable storage drive 2014, the hard disk drive 2012, or the interface 2020. Alternatively, the computer program product may be downloaded to the computing device 2000 over the communications path 2026. The software, when executed by the processor 2004, causes the computing device 2000 to perform the necessary operations to execute the method as shown in FIG. 3.

With reference to both FIGS. 1 and 2, the method according to the flow chart shown in FIG. 3 below may be implemented as software and stored in a non-transitory fashion in the secondary memory 2010 or the removable storage units 2018, 2022 of the computing device 2000 of the server 1002. The software is executable by the processor 2004 of the computing device 2000. The method provides marketing messages to a recipient (which is interchangeably referred to as a “second client” in the description below) on the basis of an algorithm that determines the degree of appeal that such marketing messages have on the recipient. The method includes the following steps as detailed below, with reference to both FIGS. 1 and 2.

### Step 302

At step 302, observation data is obtained from a first client. For example, if the observation data is stored in a database residing in the external storage drive 1008, the observation data may be obtained from the first client by receiving the observation data (depicted by the data packet 1052) from the storage drive 1008.

The observation data is associated with a second client. The “first client” may be a financial institution, such as a bank, or a payment facilitator (e.g. MasterCard®) which facilitates payments between financial entities (e.g. an acquiring bank and an issuing bank). The “second client” may be a customer/consumer of products offered by a merchant.

The observation data may include behavioral data associated with the second client, such as the second client's historical transaction data, response to previously provided marketing messages (e.g. offers) and Internet browsing history. Historical transaction data includes, but is not limited to: transaction amount, merchant identity, date/time of transaction, type of product purchased.

The observation data may also include demographic data, geographic data and social media data associated with the second client. Social media data includes data obtained from the second client's participation in social networks such as Twitter™, Facebook™, LinkedIn™, etc.

The first client aggregates and manages the observation data. However, gathering of the observation data may or may not be performed by the first client. For example, for observation data that relates to historical transaction data, the first client (a payment facilitator) may itself gather, aggregate and manage the historical transaction data. On the other hand, for observation data that relates to demographic data, a third party such as a market intelligence company may be responsible for gathering the demographic data. Thereafter, the first client aggregates and manages the demographic data.

The observation data is aggregated by the first client, processed and stored in a database. The database may reside in the secondary memory 1010 of the computing device 1000. The processing of the observation data, undertaken by the processor 1004, can include sorting and categorizing the observation data into sub-groups, e.g. historical transaction data, response to previously provided marketing messages, Internet browsing history, demographic data, geographic data and social media data. The observation data is also tagged to the second client. If the marketing message is an offer, the observation data may comprise the second client's acceptance/rejection of previously provided offers.

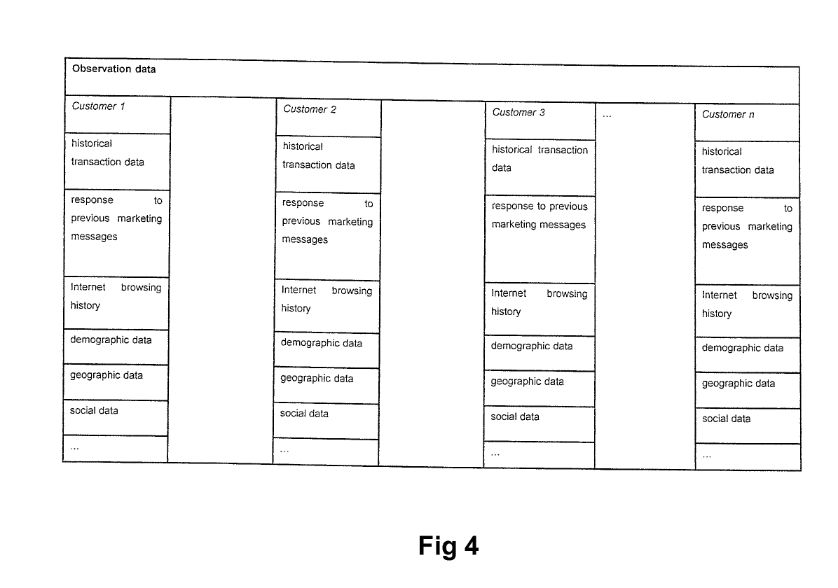

For example, the observation data can be stored in the manner shown in FIG. 4.

The step of obtaining observation data from the first client may comprise obtaining a second client identifier during a transaction at a point-of-sale terminal. For example, when the second client wishes to pay for his product, he provides a cashier with his credit card. The cashier inserts the credit card into a debit/credit card reader of a POS terminal to initiate the transaction. The second client identifier (e.g. account number), that is unique to the second client, can be extracted during this process. In this manner, the second client can be identified. Once the client is identified, the database (having stored thereon the observation data tagged to/associated with the second client) is consulted. The observation data associated with the second client is retrieved using the obtained second client identifier.

### Step 304

At step 304, a plurality of marketing messages are obtained. For example, each participating merchant submits marketing message(s) that they wish to provide to their customers (i.e. second clients). All the marketing messages from all the participating merchants are compiled and stored. The marketing messages can be stored in a database, preferably separate from the database that stores the observation data. The plurality of marketing messages are obtained by consulting/accessing the database. The database may reside in the secondary memory 2010 of the computing device 2000. Alternatively, the database may reside in the storage drive 1008 located external to the server 1002. The storage drive 1008 is in communication with the server 1002. The plurality of marketing messages may be obtained by receiving the plurality of marketing messages (depicted by the data packet 1054) from the storage drive 1008. As mentioned above, the marketing messages may be offers and/or advertisements relating to products offered by the merchant.

The plurality of marketing messages may be client-specific and stored in the database according to each participating second client. That is, in the database, each participating second client has his/her set of marketing messages from the participating merchants.

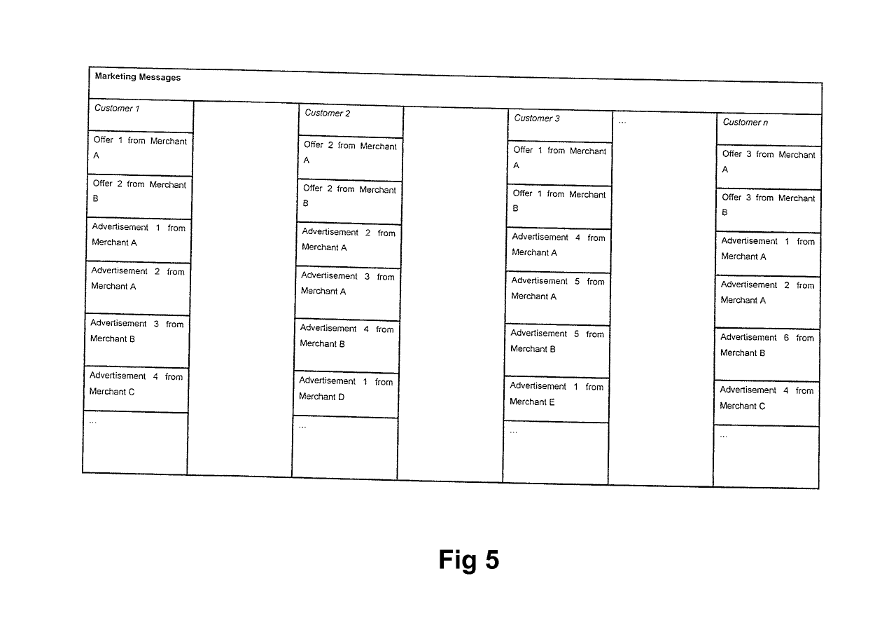

For example, the plurality of marketing messages can be stored in manner shown in FIG. 5.

If the participating merchants submit new marketing messages, the database can be refreshed accordingly. Also, a marketing campaign may last for a specific period (one month) and the marketing messages related to the marketing campaign expire after the specific period is over. Expired marketing messages are removed from the database.

### Step 306

At step 306, the plurality of marketing messages are ranked based on the observation data associated with the second client. The processor 2004 may be configured to receive the observation data and plurality of marketing messages and execute the ranking. Ranking the plurality of marketing messages may comprise processing the observation data and the marketing messages using a statistical model to generate a score indicative of the probability of the marketing message being of interest to the second client. The statistical model may be based on logistic regression.

For example, the observation data can be behavioral data associated with the second client, such as the second client's response (“yes” or “no”) to previously provided marketing messages (e.g. offers). In this case, the second client's response may include his responses for different product categories (e.g. fashion apparel, groceries, electronic goods, etc.). A score can be generated from the response for each product category so that several scores are generated if there are several categories. Each score can be used to predict the second client's probability of responding to future offers for the respective product category. The score may be calculated from an equation that is derived from, e.g. a logistic regression technique, wherein the independent variables are the observation data.

Ranking the plurality of marketing messages may be based on the generated score associated with each marketing message. For example, a higher score results in a higher ranking.

If there is more than one participating second client, ranking the plurality of marketing messages is client-specific and is performed for every participating second client. That is, the ranking involves processing both observation data (associated with a particular second client) and marketing messages (meant for the particular second client) using a statistical model to generate a score indicative of the probability of the marketing message being of interest to the particular second client.

The marketing messages are ranked such that the highest ranked marketing message is determined to be most likely to be of interest to the second client, and the lowest ranked marketing message is determined to be least likely to be of interest to the second client. Ranking allows the marketing messages to be targeted in the sense that the second client receives marketing messages which are expected to be most appealing to him/her, where the most appealing one may be presented first based on the observation data associated with the second client. In this manner, merchants are able to reach their prospective customers more effectively and marketing messages which may not appeal to customers are not sent to them.

The plurality of marketing messages may be categorized into pre-defined categories, such as product categories (e.g. fashion apparel, groceries, electronic goods, etc.). Each product category can have its own set of ranked marketing messages. A marketing message may belong to more than one product category. Second clients may opt to only receive marketing messages from selected product categories. For example, a second client who is only interested in fashion apparel can request that only fashion apparel related marketing messages are provided. This may potentially increase the second client's receptivity of the received marketing messages.

The ranking may be performed on an ad-hoc or pre-ranked basis. In the ad-hoc ranking scheme, ranking occurs whenever a transaction is initiated. When a transaction is initiated, the relevant observation data and marketing messages are retrieved from a database, and the ranking is performed. Once the ranking is completed, the marketing messages are provided accordingly (see step 308 below).

For example, the ad-hoc ranking scheme may comprise the following steps, in the following order:

1. Obtaining a second client identifier during a transaction at a point-of-sale terminal 1004. For example, when the second client wishes to pay for his product, he provides a cashier with his credit card. The cashier inserts the credit card into the debit/credit card reader to initiate the transaction. The second client identifier (e.g. account number), that is unique to the second client, can be extracted during this process. In this manner, the second client can be identified.
2. Consulting/accessing a database that stores the observation data associated with the second client. Subsequently, the observation data associated with the second client is retrieved using the obtained second client identifier. The observation data may be retrieved via a look-up procedure.
3. Consulting/accessing a database that stores a plurality of marketing messages. Subsequently, the plurality of marketing messages are retrieved. The plurality of marketing messages may be retrieved via a look-up procedure.

### <The Order of Steps 2 and 3 May Be Interchanged>

4. Using the observation data associated with the second client to rank the plurality of retrieved marketing messages.
5. Sequentially providing the ranked marketing messages to the second client in rank order (e.g. starting with the highest ranked marketing message) (see step 208 below).

In the pre-ranking scheme, ranking occurs before a transaction is initiated by the second client. The ranked marketing messages are stored in a database, and once a transaction is initiated, the database is accessed to retrieve the pre-ranked marketing messages associated with the identified customer. Thereafter, the marketing messages are provided accordingly (see step 208 below).

For example, the pre-ranking scheme may comprise the following steps, in the following order:

1. Consulting/accessing a database that stores observation data associated with a second client. Subsequently, the observation data associated with the second client is retrieved. If there is more than one second client, the step involves consulting and retrieving all the observation data associated with all participating second clients. The observation data may be retrieved via a look-up procedure.
2. Consulting/accessing a database that stores a plurality of marketing messages; and subsequently retrieving the plurality of marketing messages. If there is more than one participating second client, the step involves consulting and retrieving the marketing messages that are to be provided to each of the participating second clients. The plurality of marketing messages may be retrieved via a look-up procedure.

### <The Order of Steps 1 and 2 May Be Interchanged>

3. Using the observation data associated with the second client to rank the plurality of marketing messages. If there is more than one second client, the ranking is client-specific. That is, the marketing messages specific to a particular second client are ranked specifically for that second client.
4. Storing, in a database, the ranked marketing messages. The database may reside in the secondary memory 2010 of the computing device 2000. Alternatively, the database may reside in a storage drive 1008 located external to the server 1002. The ranked marketing messages may be stored in a format where the ranked marketing messages are grouped in a “ranked offer basket” where the “ranked offer basket” is linked to each second client, for example, through a pre-determined second client identifier.
5. Obtaining a second client identifier during a transaction at a point-of-sale terminal. For example, when the second client wishes to pay for his product, he provides a cashier with his credit card. The cashier inserts the credit card into the debit/credit card reader to initiate the transaction. The second client identifier (e.g. account number), that is unique to the second client, can be extracted during this process. In this manner, the second client can be identified.
6. Consulting/accessing the database that stores the ranked marketing messages that are linked to the second client (see step 4 above). Subsequently, the plurality of ranked marketing messages linked to the identified second client are retrieved. The retrieval may be a look-up procedure.
7. Sequentially providing the ranked marketing messages to the second client in rank order (e.g. starting with the highest ranked marketing message) (see step 308 below).

For new second clients, ad-hoc ranking is more suitable than pre-ranking as these new second clients may not have sufficient transaction history to enable reliable pre-ranking.

### Step 308

At step 308, upon identification of the second client, the ranked marketing messages are sequentially provided to the second client in rank order (e.g. starting with the highest ranked marketing message). With reference to FIGS. 1 and 2, the processor 2004 may be configured to sequentially provide the ranked marketing messages (depicted by data packet 1050) by sending the ranked marketing messages to the point-of-sale terminal 1004.

In the instance where there is more than one second client, identification of the second client prior to sequentially providing the ranked marketing messages to the second client allows the correct set of ranked marketing messages to provided. That is, the ranked marketing messages associated with a particular second client are provided to him/her, and not to another second client.

The ranked marketing messages may be provided one at a time, or more than one at a time.

The ranked marketing messages may be provided to the second client in a loop, wherein the highest ranked marketing message is provided again after all the ranked marketing messages have been provided. Alternatively, after all the ranked marketing messages have been provided, no further marketing messages are provided.

During the transaction, authentication of the second client may be performed. For example, the second client may be asked to enter his PIN at the point-of-sale terminal for authentication. The ranked marketing messages may be provided only upon successful authentication of the second client.

If the marketing message is an offer, a subsequent one of the ranked offers is provided to the second client only after a previously provided ranked offer is accepted by the second client. In other words, if the second client does not accept an offer, the next (lower ranked) offer is not provided.

It will be appreciated by a person skilled in the art that numerous variations and/or modifications may be made to one or more of the above-described embodiments without departing from the spirit or scope of the invention as broadly described in the appended claims. The above-described embodiments are, therefore, to be considered in all respects to be illustrative and not restrictive.

1. A method of providing marketing messages, comprising:
obtaining observation data from a first client, wherein the observation data is associated with a second client;
obtaining a plurality of marketing messages;
ranking the plurality of marketing messages based on the observation data associated with the second client; and
sequentially providing, upon identification of the second client, the ranked marketing messages to the second client in rank order.

2. The method of claim 1, wherein ranking the plurality of marketing messages comprises processing the observation data and the marketing messages using a statistical model to generate a score indicative of the probability of the marketing message being of interest to the second client.

3. The method of claim 2, wherein ranking the plurality of marketing messages is based on the generated score associated with each marketing message.

4. The method of claim 2, wherein the statistical model is based on logistic regression.

5. The method of claim 1, wherein the plurality of marketing messages comprises offers and/or advertisements.

6. The method of claim 1, wherein obtaining observation data from the first client comprises:
obtaining a second client identifier during a transaction at a point-of-sale terminal;
consulting a database having stored thereon the observation data associated with the second client; and
retrieving the observation data associated with the second client using the obtained second client identifier.

7. The method of claim 1, wherein obtaining observation data from the first client comprises obtaining a second client identifier during a transaction at a point-of-sale terminal; and after the step of ranking the plurality of marketing messages, the method further comprises storing in a database, the ranked marketing messages that are linked to the second client identifier.

8. The method of claim 6, further comprising authenticating the second client during the transaction and wherein the step of providing the ranked marketing messages further comprises transmitting the ranked marketing messages to the point-of-sale terminal upon successful authentication of the second client.

9. The method of claim 7, further comprising authenticating the second client during the transaction and wherein the step of providing the ranked marketing messages further comprises transmitting the ranked marketing messages to the point-of-sale terminal upon successful authentication of the second client.

10. The method of claim 1, wherein the observation data comprise one of more of: the second client's historical transaction data, demographic data, geographic data, social media data and Internet browsing history.

11. The method of claim 1, wherein the marketing messages comprise offers and the observation data comprise the second client's response to previously provided offers.

12. The method of claim 1, wherein the marketing messages comprise offers so that ranking of the marketing messages provides ranked offers, wherein a subsequent one of the ranked offers is provided after a previously provided ranked offer is accepted by the second client.

13. The method of claim 1, wherein sequentially providing the ranked marketing messages to the second client comprises providing one marketing message at a time.

14. The method of claim 1, wherein sequentially providing the ranked marketing messages to the second client comprises providing more than one marketing message at a time.

15. The method of claim 1, further comprising providing the ranked marketing messages to the second client in a loop, wherein a highest ranked marketing message is provided again after all the ranked marketing messages have been provided.

16. A system for providing marketing messages, comprising:
at least one processor; and
at least one memory including computer program code;
the at least one memory and the computer program code configured to, with at least one processor, cause the system at least to:
obtain observation data from a first client, wherein the observation data is associated with a second client;
obtain a plurality of marketing messages;
rank the plurality of marketing messages based on the observation data associated with the second client; and
sequentially provide, upon identification of the second client, the ranked marketing messages to the second client in rank order.

17. A point-of-sale terminal adapted to receive and display marketing messages provided by the method of claim 1.

18. A computer-readable storage medium having stored thereon computer program code which when executed by a computer causes the computer to execute a method according to claim 1.

19. A computer program comprising software code adapted to perform a method according to claim 1.
